(19) United States
(12) Patent Application Publication
(10) Pub. No.: US 2026/0369182 A1
(43) Pub. Date: Nov. 19, 2026

(54) INJECTION SIMULATION DEVICE

(71) Applicant: Sanofi, Paris (FR)

(72) Inventors: Jan Torben Eickriede, Frankfurt am Main (DE); Michael Jugl, Frankfurt am Main (DE); Dominik Kutz, Rüsselsheim (DE); Peter Nober, Rüsselsheim (DE); Martin Vitt, Frankfurt am Main (DE)

(21) Appl. No.: 19/158,749

(22) PCT Filed: Feb. 21, 2024
(86) PCT No.: PCT/EP2024/054360

§ 371 Date: Aug. 21, 2025

(30) Foreign Application Priority Data
Feb. 22, 2023 (EP) 23315038.2

(51) Int. Cl. G09B 23/28

(52) U.S. Cl. CPC G09B 23/285

(57) ABSTRACT

The present disclosure relates to an injection simulation device operable to simulate an injection of a dose of a medicament, the injection simulation device comprising
a housing defining a longitudinal direction,
a rotatable element arranged inside the housing, rotatable relative to the housing and constrained to the housing with regard to the longitudinal direction
a trigger manually operable by a user to initiate or to control the simulated injection of the dose,
a mechanical coupling mechanically engaged with the trigger and with the rotatable element, the mechanical coupling being operable to induce or to transfer operation of the trigger into a rotation of the rotatable element relative to the housing along a first sense of rotation,
a brake unit fixed to the housing and in torque-proof engagement with the rotatable element, the brake unit being operable to apply a braking force or braking momentum onto the rotatable element.

### CROSS-REFERENCE TO RELATED APPLICATIONS

The present application is the national stage entry of International Patent Application No. PCT/EP2024/054360, filed on Feb. 21, 2024, and claims priority to European Application No. 23315038.2, filed on Feb. 23, 2023, the disclosures of which are incorporated herein by reference.

### TECHNICAL FIELD

The present disclosure relates to an injection simulation device also denoted as injection training devices and further relates to a method of simulating injection of a dose of a medicament

### BACKGROUND

Drug delivery devices for setting and dispensing a single or multiple doses of a liquid medicament are as such-known in the art. Generally, such devices have substantially a similar purpose as that of an ordinary syringe.

Drug delivery devices, such as pen-type injectors, have to meet a number of user-specific requirements. For instance, with patient's suffering chronic diseases, such as diabetes, the patient may be physically infirm and may also have impaired vision. Suitable drug delivery devices especially intended for home medication therefore need to be robust in construction and should be easy to use. Furthermore, manipulation and general handling of the device and its components should be intelligible and easy understandable. Such injection devices should provide setting and subsequent dispensing of a dose of a medicament of variable size. Moreover, a dose setting as well as a dose dispensing procedure must be easy to operate and has to be unambiguous.

For patients or users being unfamiliar with the use of such injection devices it would be beneficial to provide a training or simulations device by way of which the user or patient can train or simulate the process of setting of a dose and dispensing or injecting of a dose without injecting a medicament. With all-mechanically implemented as well as with semi-or fully-automated injection devices, such as injection pens a user may have to apply a substantial dispensing force to initiate and/or to control the process of dose injection. Here, a user may have to exert a dispensing force that is larger than inherent friction or counter forces of the injection devoice. Such counter forces or friction is mainly governed by a sliding and frictional engagement between a sidewall of a barrel of a medicament container and a stopper or bung movably disposed inside the barrel. In addition, some medicaments may exhibit a comparatively large degree of viscosity. There must be hence applied a rather large fluid or dispensing pressure to urge the medicament through an injection needle of limited diameter.

It is hence desirable to provide an injection training device or injection simulation device allowing a user to train or to simulate setting and/or dispensing of a dose. The simulation or training device should provide realistic mechanical feedback to a user. It should therefore rather precisely mimic the operability of existing injection devices. The simulation or training device should be easy and intuitive in use. It should be rather robust and long-lasting. It should further provide a kind of an infinite feedback without a need of being reset by a user after being used only a few times.

### SUMMARY

In one aspect the present disclosure relates to an injection simulation device operable to simulate an injection of a dose of a medicament. The injection simulation device comprises a housing. The housing defines a longitudinal direction. The housing may be of elongated shape. The housing may be of cylindrical or tubular shape. The injection simulation device further comprises a rotatable element arranged inside the housing and being rotatable relative to the housing. The rotatable element is constrained to the housing with regards to the longitudinal direction. In some examples the rotatable element is longitudinally locked to the housing. It may be blocked from a longitudinal movement relative to the housing.

The rotatable element may be movable, e.g. rotatable relative to the housing only with regards to a circumferential direction but may be locked to the housing with regards to the longitudinal direction. In other words, the rotatable element may be free to rotate relative to the housing, typically with regards to an axis of rotation extending in the longitudinal direction or extending parallel to the longitudinal direction. The rotatable element may be longitudinally fixed to the housing and may be prevented from moving translationally in longitudinal direction relative to the housing.

The injection simulation device further comprises a trigger manually operable by a user to initiate and/or to control the simulated injection of the dose. In some examples the trigger may be manually operable by a user to initiate and to control the simulated injection of the dose.

The injection simulation device further comprises a mechanical coupling, which is mechanically engaged with the trigger and with the rotatable element. The mechanical coupling is operable to induce or to transfer operation of the trigger into a rotation of the rotatable element relative to the housing along a first sense of rotation. This way and by the mechanical coupling an actuation of the trigger may induce or cause the rotatable element to rotate along the first sense of rotation. In some examples operation of the trigger may be accompanied by a user-induced movement of the trigger relative to the housing, e.g. in distal direction, which movement of the trigger may be transferred via the mechanical coupling into a rotation of the rotatable element relative to the housing along the first sense of rotation.

The injection simulation device further comprises a brake unit fixed to the housing and in torque-proof engagement with the rotatable element. The brake unit is operable to apply a braking force or braking momentum onto the rotatable element. In particular, the brake unit simulates and/or provide a counter force acting on the rotatable element, which counterforce or counter momentum mimics a mechanical resistance of an injection device, e.g. a mechanical resistance, which might be due to a viscosity of a medicament to be urged or expelled through an outlet of a medicament container and/or through an injection needle as well as a mechanical resistance provided by a stopper or bung sealingly engaged with a barrel of a medicament container, which bung or stopper has to be displaced relative to the barrel in a distal direction for expelling a dose of the medicament.

The brake unit may be longitudinally fixed to the housing. The brake unit may be provided as a separate part and/or as an encapsulated unit, which is suitable for arranging and fixing inside a housing of an injection device, which injection device, due to the installation of the brake unit may adapt the function of an injection simulation device.

The brake unit is configured to provide a well-defined braking force or braking momentum when the rotatable element is subject to a rotation as induced by the trigger of the injection simulation device. The brake unit may be operable to provide a braking force or braking momentum irrespective of an angular position of the rotatable element. This way, the injection simulation device does not require to be manually reset by a user, e.g. after having conducted or executed an injection simulation. In addition, the brake unit may be free of wear. The injection simulation device and the brake unit may be hence rather long-lasting and may provide an unaltered functionality over the entire lifetime of the injection simulation device.

In another example the brake unit of the injection simulation device is operable to apply a braking force or braking momentum of variable magnitude onto the rotatable element. Here, the magnitude of the braking force or braking momentum varies with an angular velocity of the rotatable element relative to the housing. This way, there can be provided a velocity-dependent braking force or braking momentum for the rotatable element, which provides a rather realistic simulation of an injection procedure and the associated counter forces, which are mainly due to friction of the stopper or bung with the sidewall of the barrel of a cartridge or medicament container and due to the viscosity of the injectable fluid expelled through an outlet and/or through an injection needle connected to the outlet of a medicament container.

Generally, the brake unit can be implemented in numerous different ways. It is particularly adapted and configured to apply a braking force or braking momentum on a rotatable element, which is immovable with regard to the longitudinal direction and which is exclusively rotationally supported relative to the housing of the injection simulation device. With this longitudinal constriction of the rotatable element, a large variety of different braking mechanisms can be implemented for putting the brake unit into practice.

In another example the magnitude of the braking force or braking momentum applicable by the brake unit onto the rotatable element increases with an increasing angular velocity of the rotatable element. Such a behavior or response of the brake unit is of particular benefit since it mimics real or realistic forces or counterforces that arise in an injection device, for which the present injection simulation device is adapted to.

With the same or with another example the magnitude of the braking force or braking momentum applicable by the brake unit onto the rotatable element decreases with a decreasing angular velocity of the rotatable element. With a rather slow motion and hence with a rather low angular velocity of the rotatable element, which is typically associated with a rather slow injection procedure, the counterforces, e.g. arising due to the viscosity of the medicament expelled through an injection needle are comparatively low. Such counterforces may substantially increase with an increase of the injection velocity and hence with an increase of the angular velocity of the rotatable element. The braking unit providing a velocity-dependent braking momentum and/or velocity-dependent braking force therefore provides a rather realistic simulation of counterforces that arise with an injection device during a dose injection procedure.

With the brake unit of the injection simulation device there can be conducted and executed an injection simulation procedure without the necessity to expel a fluid from a medicament container, such as a cartridge. The injection simulation device therefore does not have to be equipped with a dummy cartridge, e.g. filled with water for injection or a placebo. Furthermore, and since the injection simulation device may be void of a medicament container or cartridge, it may not be necessary to exchange such a container or cartridge, which exchanging process would otherwise typically involve a disassembly an re-assembly of the housing of the injection device.

Furthermore, and since the rotatable element engaged with the brake unit is longitudinally constrained relative to the housing the injection simulation mechanism of the injection simulation device does not have to be reset. It can be repeatedly used in a rather infinite way, i.e. without resetting of an injection simulation mechanism.

According to another example the rotatable element comprises a longitudinal rod. The rotatable element may be implemented as a longitudinal rod or may consist of a longitudinal rod. The rotatable element may represent or may substitute a piston rod of a drive mechanism of an injection device with the exception that the rotatable element is longitudinally constraint inside and/or relative to the housing of the injection device. The longitudinal rod may be mechanically engaged with a dose setting and dose dispensing mechanism of an injection simulation mechanism, which apart from the rotatable element or longitudinal rod may be identically shaped and configured as a drive mechanism and/or dose setting mechanism of an injection device.

In some examples the present injection simulation device may be directly derived from a real injection device, such as a pen-type injector. Here, only a piston rod, which is configured to directly abut in longitudinal direction with a stopper or piston of a medicament container for urging or driving the same in a distal dispensing direction, has to be replaced by the rotatable element, which may be void of a particular thread or helical structure in threaded engagement with a housing part, e.g. with a flange or web of the housing of the injection device or injection simulation device.

According to a further example the rotatable element comprises a distal end, which is rotatably supported by a pivot bearing. The pivot bearing may comprise a ball bearing or the like rotatable bearing by way of which the distal end of the rotatable element and hence the distal end of the longitudinal rod of the rotatable element can be constrained and/or fixed with regards to a transverse plane extending perpendicular to the longitudinal direction of the housing.

By way of a pivot bearing mechanically engaged with the distal end of the rotatable element, the distal end of the rotatable element can be kept and/or fixed in a rather stable way inside the housing of the injection simulation device. Providing of a pivot bearing and thereby implementing a rather stable support for the distal end of the rotatable element is of particular benefit to apply a well-defined braking force or braking momentum onto the rotatable element.

A rather stable rotary support, e.g. in form of a pivot bearing at the distal end of the rotatable element, allows to arrange the brake unit at or near the distal end of the rotatable element. A precise rotatable support for the distal end of the rotatable element may be a prerequisite for a precise and reliable braking or retarding of the rotating rotatable element by way of the brake unit.

In some examples the pivot bearing may be integrated into the brake unit. Then, the distal end of the rotatable element may be rotatably supported by a tapered bearing of the brake unit. In other examples the pivot bearing may be external to the brake unit and the brake unit may be arranged in a well-defined position or configuration relative to the pivot bearing. In either way, the brake unit is configured to provide a rather precise and well-defined braking force or braking momentum onto the rotating rotatable element.

In another example the brake unit comprises a mount for the distal end of the rotatable element. The mount may coincide with the pivot bearing or may be integrated into the pivot bearing. In other examples the mount for the distal end of the rotatable element may be rotatably supported by the pivot bearing. Then, the pivot bearing may be implemented or integrated into the brake unit. The mount of the brake unit is configured to establish or to form a torque-proof and hence torque-transmitting mechanical connection or mechanical coupling with the rotatable element. When the rotatable element is duly attached or connected to the mount of the brake unit the rotatable element may be rotationally locked to the mount, such that the mount of the brake unit rotates in unison with the rotatable element.

By way of the mount, a rotary motion or rotating movement and hence an angular momentum can be transferred from the rotatable element to the mount and hence to the brake unit. The brake unit may then provide a respective braking force or braking momentum by way of which the rotation of the rotatable element can be counteracted and hence retarded.

In another example the mount comprises a mechanical coupling structure complementary shaped to a mechanical counter coupling structure of the rotatable element. The coupling structure may comprise a keying and the counter coupling structure may comprise a respective counter keying, that matches the keying. The mechanical coupling structure and hence the mechanical coupling of the mount comprises a symmetry braking feature, which is complementary shaped to a respective symmetry braking feature of the counter coupling structure or counter coupling of the rotatable element.

By way of the mutually corresponding symmetry braking features of the counter coupling structure and the coupling structure the rotatable element may transfer an angular momentum to the mount of the brake unit when subject to a rotation, e.g. induced or controlled by the trigger of the injection simulation device.

In another example the brake unit comprises a brake element with a radial facing friction surface to frictionally engage with a complementary shaped circumferential counter friction surface of the rotatable element. The brake element may comprise a kind of a cantilever or rim braking element, e.g. facing radially inwardly to an outside friction surface of the rotatable element. In another example the radial facing friction surface of the brake element may face radially outwardly to frictionally engage with a complementary shaped circumferential but inside facing counter friction surface of a hollow rotatable element.

In either way, the brake unit may be implemented as a friction brake. The brake element may be implemented as a brake shoe. It may be movably or adjustably arranged in or on the brake unit so as to compensate eventual mechanical wear of any one of the friction surface or counter friction surface, which frictionally engage mutually to apply a braking force or braking momentum onto the rotatable element.

In some examples the brake element may be biased radially inwardly or radially outwardly to apply a well-defined radially directed contact pressure between the brake element and the rotatable element.

In another example the brake unit comprises a cylindrical cavity containing a dampening fluid. Here, the brake unit may be implemented as kind of a viscous brake unit. The dampening fluid may mechanically engage with the rotatable element and may dampen or at least retard a rotational movement of the rotatable element. The dampening fluid may comprise a comparatively large viscosity. At room temperature it may comprise a viscosity of more than 1 mPAs. In some examples it comprises a viscosity of larger than 2 mPAs, larger than 2.5 mPAs, larger than 10 mPAs, larger than 50 mPAs or larger than 100 mPAs.

The dampening fluid may comprise or contain at least one of the following materials: water, silicone, silicone oil, glycerine, mineral oil, vegetable oil or the like pasty or highly viscous media. In some examples the dampening fluid exhibits a temperature dependent viscosity. It may become subject to a substantial heating as it is stirred and/or as it is subject to shear forces inside the cavity. With an increasing temperature the dampening fluid may exhibit an increased or decreased viscosity.

In a further example the brake unit comprises a brake element immersed in the dampening fluid and movable inside the cylindrical cavity thereby stirring the dampening fluid or moving relative to the dampening fluid. The viscosity of the dampening fluid may invoke or induce a braking or retarding effect on the movement of the brake element located inside the cylindrical cavity and/or immersed in the damping fluid.

The braking element inside the cylindrical cavity may be mechanically connected and may be rotationally locked to the rotatable element, e.g. via the mount of the brake unit. Hence, the rotatable mount of the brake unit, which is mechanically engaged or which is mechanically engageable with the rotatable element, may be mechanically or rigidly connected to the brake element located inside the cylindrical cavity and may be surrounded or flushed or washed round by the dampening fluid.

The dampening fluid has a retarding and hence braking effect on a movement or rotation of the braking element inside the cylindrical cavity. In this way and when the braking element as immersed in the dampening fluid is in rotationally locked and hence torque transmitting engagement with the rotatable element, the dampening fluid provides a respective braking force or braking momentum onto the rotatable element via the braking element in dampening fluid.

In another example the brake unit comprises a shaft rotatable inside a unit housing of the brake unit. The unit housing may comprise the cylindrical cavity or may substantially coincide with the cavity. One of the shaft and the unit housing is rotationally locked to the rotatable element. The other one of the shaft and the unit housing is rotationally locked to the housing of the injection simulation device. The rotatable shaft may be entirely located inside the unit housing and hence inside the cylindrical cavity of the brake unit. In some examples the cylindrical cavity may coincide with the unit housing or may constitute the unit housing. In other examples the cylindrical cavity may be part of the unit housing of the brake unit.

In some examples the rotatable shaft inside the unit housing is in torque proof or torque transmitting engagement with the rotatable element. It may be mechanically engaged with the rotatable element via the mount of the brake unit. The mount may be rotationally locked with one end to the rotatable shaft and may be lockable or may be rotationally locked to the rotatable element with an opposite longitudinal end.

The shaft may be rotationally supported inside the unit housing and/or inside the cylindrical cavity by the pivot bearing. In some examples a distal end of the rotatable shaft of the brake unit is rotationally supported by the pivot bearing, e.g. on a bottom of the unit housing. An opposite proximal end of the rotatable shaft may be provided with or fixed to the mount, which in turn is connected in a torque proof and hence in a rotationally locked manner with the rotatable element. Here, the pivot bearing in or on which the distal end of the rotatable element is rotatably supported inside the housing, is or forms part of the brake unit.

In some examples the rotatable shaft of the brake unit is or forms a longitudinal extension of the distal end of the rotatable element. With one of the shaft and the unit housing being rotationally locked to the rotatable element and with the other one of the shaft and the unit housing being rotationally locked to the housing there can be provided a well-defined braking force or braking momentum for the rotatable element by applying or by providing a respective brake force or brake momentum between the shaft and the unit housing or cavity of the brake unit. Such a brake force or brake momentum may be easily and hence inherently provided by the dampening fluid.

In another example the brake unit comprises at least one of a lamella and a blade fixed to one of the shaft and the unit housing. The at least one of the blade and the lamella is or are immersed in the dampening fluid and extend radially from one of the shaft and the unit housing. When the unit housing is fixed to the housing of the injection simulation device the shaft is rotationally locked or connected to the rotatable element. Then, the at least one lamella or the blade is rotationally fixed to the shaft and is subject to a rotational movement relative to the unit housing as the rotatable element is subject to a rotation along the first sense of rotation relative to the housing of the injection simulation device.

Due to the dampening fluid located inside the unit housing or cavity there is inherently provided a respective dampening and hence braking effect on the lamella or blade, which is in torque proof and hence torque transmissive connection or engagement with the shaft.

In another example it is also conceivable that the unit housing is rotationally locked to the rotatable element. Then, the shaft of the brake unit is rotationally locked with the housing of the injection simulation device. Typically, that one of the shaft and the unit housing, which is rotationally locked to the rotatable element is typically provided with at least one of the lamella and the blade. Then and in the course of a rotation of the rotatable element relative to the housing the respective lamella or blade is subject to a movement inside the dampening fluid, which movement is then counteracted and/or retarded by the viscosity and hence the inherent mechanical friction provided by the dampening fluid.

In another example the brake unit comprises at least a first lamella and a second lamella. The first lamella and the second lamella is or are fixed to one of the shaft and the unit housing at a longitudinal distance from each other. The brake unit further comprises at least a first counter lamella fixed to the other one of the shaft and the unit housing. The counter lamella is provided or arranged longitudinally between the first lamella and the second lamella. There may be provided also numerous counter lamellas. The total number of counter lamellas may be equal to the total number of lamellas.

The brake unit may comprise numerous interleaved lamellas and counter lamellas, e.g. of disc-like shape being at least partially or completely immersed in the dampening fluid.

By modifying a longitudinal distance between first and second lamellas, and/or by modifying a longitudinal gap size between counter lamellas and/or by modifying a longitudinal gap size between lamellas and counter lamellas the braking or retarding effect can be modified accordingly and adapted to the demands of the brake unit.

In another example a dampening effect, a retarding force, braking force or braking momentum can be varied by selecting the appropriate dampening fluid.

In some examples the brake unit may comprise or resemble a viscous coupling or viscous brake. Since a braking force of braking effect is derived from the viscosity and hence of the shear effect of the dampening fluid between moving parts or brake elements of the brake unit, the brake unit can be implemented rather wear-less, thus allowing to increase the lifetime of the brake unit and hence the lifetime of the injection simulation device. Also, intervals for maintenance of the inspection simulation device and/or of the brake unit can be extended almost infinitely.

In another example of the injection simulation device the brake unit comprises a first blade and at least a second blade fixed to one of the shaft and the unit housing. The first blade and the second blade protrude from the shaft or from the unit housing in a radial and longitudinal direction. Also here, and since the first and the second blades are immersed at least partially or even completely in the dampening fluid, a movement of the first and the second blades, which may be induced by a rotation of the shaft relative to the unit housing, inherently comes along with a stirring and/or with a shear effect applied to the dampening fluid. This induces a respective retarding effect and provokes a respective braking force or braking momentum.

Also here, the number and the geometry, e.g. the size and/or the shape of the first blade and/or of the second blade has a substantial impact or influence on the braking force or braking momentum.

Also here and by using a dampening fluid with a suitable viscosity, a desired braking effect or braking capability of the brake unit can be provided. Also, the number of the blades fixed to the rotatable shaft can be varied in order to provide a braking effect of desired magnitude or characteristic.

In another example at least one of the lamella and the blade comprises at least one of a through opening and a grid structure. The lamella may comprise a disc-shaped planar structure with through openings extending therethrough in longitudinal direction. The lamella may be rotationally supported inside the unit housing around the shaft. The individual lamella or lamellas may extend in a transverse plane, i.e. perpendicularly to the elongation of the shaft, wherein the shaft forms or constitutes an axis of rotation for the lamella.

The blade or the blades extend radially outwardly from the shaft or radially inwardly from a sidewall of the cavity or unit housing. The blade or the blades may also extend in longitudinal direction. The blade as well as the lamella may comprise one or numerous through openings by way of which a dampening or retarding effect can be further increased when the respective blade(s) or lamella(s) is (are) subject to a motion or movement when immersed in the dampening fluid. Also here, and by varying the geometry, the size, the density and/or or the number of through openings in the lamella and/or the blade the braking force or braking momentum as well as a braking characteristic of the brake unit can be designed or modified accordingly.

With some examples the lamella or blade may comprise a kind of a grid structure comprising of providing a regular or irregular configuration of through openings extending through at least one of the blade and the lamella. With a grid structure a dampening or retarding effect can be further modified. In this way and e.g. by precisely designing a brake unit by selecting a suitable dampening fluid in combination with a specific arrangement of blades and lamellas relative to each other and/or by providing through openings through the lamella and/or blades of a specific geometry, density and size, there can be provided a well-defined braking behavior of the brake unit, which may precisely mimic or simulate mechanical counterforces that typically arise with an injection device in the course of conducting an injection procedure.

The injection simulation device as described herein can be universally adapted to almost any kind of injection devises, and in particular to almost any kind of injection pens provided that the respective injection pen comprises or can be equipped a rotatable element as described herein. The injection simulation device may mimic an all-mechanically implemented injection pen comprising a dial extension movable relative to the housing of the injection device in proximal direction in a helical motion and being movable relative to the housing in a distal direction for injecting of a dose. Here, a user may have to provide the entirety of a dispensing force required for expelling and/or injecting the liquid medicament.

In further examples, the injection simulation device mimics operation of a semi-or fully automated injection pen, where at least a portion or the entirety of the dispensing or injection force required for injecting the medicament is partially or fully provided by an energy storage, e.g. implemented as a mechanical or electrical energy storage.

According to a further example the trigger of the injection simulation device is movable from a first position, e.g. a proximal position, to a second position, e.g. a distal position, by manually applying a dispensing force onto the trigger. The magnitude of the dispensing force required for moving the trigger towards and/or into the second position may be governed by or may depend on the braking effect as provided by the brake unit.

Hence, by varying the braking force or braking momentum applied onto the rotatable element the dispensing force required to move the trigger from the first position to the second position may vary accordingly.

According to a further example a distance between the first position and the second position correlates with the degree of rotational displacement of the rotatable element. Insofar, the trigger movement may be directly correlated to the rotational movement of the rotatable element. Here, a magnitude of a trigger movement, e.g. a longitudinal rigger movement, may directly correlate to the degree or magnitude of a rotational displacement of the rotatable element.

The larger the distance between the first and the second position for the trigger movement, the larger will be the rotational displacement of the rotatable element.

In some examples, the trigger and the rotatable element may be permanently mechanically engaged, e.g. by way of a gear or gearing mechanism. This way, e.g. a translational, longitudinal or helical movement of the trigger relative to the housing may be transferred into a rotational movement of the rotatable element relative to the housing. The more the trigger will be moved in longitudinal direction the larger will be the rotational movement of the rotatable element during the trigger movement.

If during an operation of the trigger the force applied by a user onto the trigger may be lower than the dispensing force required to move the trigger, the trigger movement will stop. Interruption of the trigger movement will immediately lead to a respective interruption of a rotational movement of the rotatable element; and vice versa.

In some examples, the rotational element may be rotatable endlessly. It may be void of a stop feature by way of which a rotational movement could be stopped or interrupted.

According to a further example a magnitude of the dispensing force required to move the trigger from the first position to the second position depends on a magnitude of the braking force or breaking momentum applied by the brake unit onto the rotatable element. This way, the brake unit provides a tactile and/or mechanical feedback to the user and into move or to depress the trigger. This way, the brake unit may mimic the mechanical resistance typically provided by a cartridge filled with a medicament, when a stopper of the cartridge is moved in distal direction for expelling the medicament from the cartridge.

In another aspect the present disclosure relates to a method of simulating an injection of a medicament. The method comprises the steps of providing an injection simulation device as described above and conducting an injection simulation by actuating the trigger of the injection simulation device.

Since the method makes use of an injection simulation device as described above, all features, effects and benefits as described above in connection with the injection simulation device equally apply to the method of simulating the injection; and vice versa.

In another aspect the present disclosure also relates to a method of designing, calibrating or tuning of an injection simulation device. This method comprises the step of providing an injection device, replacing of a piston rod of the injection device by a rotatable element and longitudinally constraining the rotatable element with respect or relative to the housing of the injection device.

The method further comprises providing of a brake unit and mechanically engaging the brake unit with the rotatable element. In this way the method provides deriving of an injection simulation device from an injection device.

In further examples the method of designing, calibrating or tuning the injection simulation device comprises the step of tuning or calibrating the brake unit. Here, the brake unit is provided with a cylindrical cavity containing a dampening fluid. Tuning or calibrating of the brake unit includes selecting of a dampening fluid out of a variety of available dampening fluids and filling the cylindrical cavity of the brake unit with the selected dampening fluid.

The method of designing, calibrating or tuning the injection simulation device further comprises providing a brake unit comprising a shaft rotatable inside a unit housing, which unit housing comprises a cylindrical cavity, which is at least partially or which is completely filled by the dampening fluid.

The method further comprises to provide the brake unit with at least one of a lamella and a blade fixed to one of the shaft and the unit housing and immersing the at least one of the lamella and the blade in the dampening fluid.

In another example and for tuning or calibrating the braking behavior of the brake unit the method comprises the steps of modifying or selecting a geometry or size of at least one of the lamella and the blade and/or or to modify a number of lamellas or blades and and/or to modify at least one of a distance and an orientation of at least one of the lamella relative to another lamella and/or to modify a distance or orientation of at least one of the blades relative to another blade.

In a further example the method of tuning or calibrating the brake unit of the injection simulation device comprises the step of varying at least one of a size, a density or geometry of through openings extending through at least one of the lamella and the blades of the brake unit. Modifying at least one of the lamella and the blade may always include to select a respective lamella or blade out of a variety of available lamellas or blades, which distinguish from each other by at least one of the following parameters: size, geometry, relative distance, relative orientation, number of through openings extending through the blade or lamella, density of through openings in the respective blade or lamella, size and/or geometry of through opening(s) extending through the respective lamella or blade.

In some examples of the injection simulation device the injection simulation device is directly derived from an existing injection device. Here, only a piston rod, which may be in threaded engagement with a web or flange of a housing of the injection device may have to be replaced by the rotatable element of the injection simulation device. The overall size and shape of the rotatable element may be comparable to the overall size and shape of the original piston rod of the injection device. It may be only the distal end of the rotatable element, that is rotationally locked or coupled to the brake unit, which is provided as a separate unit to the injection device. Upon replacing the piston rod of the injection device by the rotatable element and hence by a longitudinal rod, the rotatable element may distinguish from the original piston rod by the absence of a threaded structure at or near its distal end.

While the original piston rod of the injection device may be threadedly engaged with an inner thread provided at or in the housing of the injection device, with the injection simulation device the rotatable element may be simply rotationally supported by a pivot bearing. Here, the pivot bearing may inhibit a longitudinal displacement of the piston rod when subject to a rotation, e.g. when a user conducts or executes a dose dispensing procedure and hence a simulated dose injection.

With some examples the injection simulation device comprises a dial extension, which is movable in longitudinal proximal direction relative to the housing of the injection device during setting of a dose. Here, the injection simulation device may not only simulate injecting of a dose but also setting of a dose of individual or user-selectable size. With a so-called dial extension-type injection simulation device a user may apply a distally directed dispensing force onto the dial extension. The dial extension may be provided with the trigger, which has to be manually depressed in distal direction, e.g. by a thumb of a user. Depressing of the trigger may rotationally lock a drive member or drive sleeve relative to the housing. The drive member or drive sleeve may be threadedly engaged with the rotatable element, e.g. with a proximal end of the rotatable element. In the course of dispensing or injecting of a dose the user exerting a distally directed pressure onto the dial extension may induce a purely longitudinal sliding movement of the driver or drive sleeve, which due to the threaded engagement with the rotatable element causes the rotatable element to rotate.

In the course of setting of a dose a user may rotate a dose dial of the dial extension, which may induce a rotation of the drive member. During dose setting, the drive member may be rotationally locked to the housing. It may be permanently locked against a rotation along a second sense of rotation, which is opposite to the first sense of rotation. Accordingly, the dialing or rotating motion of the dose dial and/or of the dial extension may be transferred into a respective rotating motion of the drive sleeve, which due to the threaded engagement with the stationary rotatable element becomes subject to a helical motion towards the proximal direction. This way, the dial extension starts to move in a helical manner in proximal direction relative to the housing until a dose of desired size has been set.

Generally, the scope of the present disclosure is defined by the content of the claims. The transportation device is not limited to specific embodiments or examples but comprises any combination of elements of different embodiments or examples. Insofar, the present disclosure covers any combination of claims and any technically feasible combination of the features disclosed in connection with different examples or embodiments.

The terms “drug” or “medicament” are used synonymously herein and describe a pharmaceutical formulation containing one or more active pharmaceutical ingredients or pharmaceutically acceptable salts or solvates thereof, and optionally a pharmaceutically acceptable carrier. An active pharmaceutical ingredient (“API”), in the broadest terms, is a chemical structure that has a biological effect on humans or animals. In pharmacology, a drug or medicament is used in the treatment, cure, prevention, or diagnosis of disease or used to otherwise enhance physical or mental well-being. A drug or medicament may be used for a limited duration, or on a regular basis for chronic disorders.

As described below, a drug or medicament can include at least one API, or combinations thereof, in various types of formulations, for the treatment of one or more diseases. Examples of API may include small molecules having a molecular weight of 500 Da or less; polypeptides, peptides and proteins (e.g., hormones, growth factors, antibodies, antibody fragments, and enzymes); carbohydrates and polysaccharides; and nucleic acids, double or single stranded DNA (including naked and cDNA), RNA, antisense nucleic acids such as antisense DNA and RNA, small interfering RNA (siRNA), ribozymes, genes, and oligonucleotides. Nucleic acids may be incorporated into molecular delivery systems such as vectors, plasmids, or liposomes. Mixtures of one or more drugs are also contemplated.

The drug or medicament may be contained in a primary package or “drug container”. The drug container may be, e.g., a cartridge, syringe, reservoir, or other solid or flexible vessel configured to provide a suitable chamber for storage (e.g., short- or long-term storage) of one or more drugs. For example, in some instances, the chamber may be designed to store a drug for at least one day (e.g., 1 to at least 30 days). In some instances, the chamber may be designed to store a drug for about 1 month to about 2 years. Storage may occur at room temperature (e.g., about 20 °C), or refrigerated temperatures (e.g., from about −4 °C to about 4 °C). In some instances, the drug container may be or may include a dual-chamber cartridge configured to store two or more components of the pharmaceutical formulation to-be-administered (e.g., an API and a diluent, or two different drugs) separately, one in each chamber. In such instances, the two chambers of the dual-chamber cartridge may be configured to allow mixing between the two or more components prior to and/or during dispensing into the human or animal body. For example, the two chambers may be configured such that they are in fluid communication with each other (e.g., by way of a conduit between the two chambers) and allow mixing of the two components when desired by a user prior to dispensing. Alternatively or in addition, the two chambers may be configured to allow mixing as the components are being dispensed into the human or animal body.

The drugs or medicaments contained in the drug delivery devices as described herein can be used for the treatment and/or prophylaxis of many different types of medical disorders. Examples of disorders include, e.g., diabetes mellitus or complications associated with diabetes mellitus such as diabetic retinopathy, thromboembolism disorders such as deep vein or pulmonary thromboembolism. Further examples of disorders are acute coronary syndrome (ACS), angina, myocardial infarction, cancer, macular degeneration, inflammation, hay fever, atherosclerosis and/or rheumatoid arthritis. Examples of APIs and drugs are those as described in handbooks such as Rote Liste 2014, for example, without limitation, main groups 12 (anti-diabetic drugs) or 86 (oncology drugs), and Merck Index, 15th edition.

Examples of APIs for the treatment and/or prophylaxis of type 1 or type 2 diabetes mellitus or complications associated with type 1 or type 2 diabetes mellitus include an insulin, e.g., human insulin, or a human insulin analogue or derivative, a glucagon-like peptide (GLP-1), GLP-1 analogues or GLP-1 receptor agonists, or an analogue or derivative thereof, a dipeptidyl peptidase-4 (DPP4) inhibitor, or a pharmaceutically acceptable salt or solvate thereof, or any mixture thereof. As used herein, the terms “analogue” and “derivative” refers to a polypeptide which has a molecular structure which formally can be derived from the structure of a naturally occurring peptide, for example that of human insulin, by deleting and/or exchanging at least one amino acid residue occurring in the naturally occurring peptide and/or by adding at least one amino acid residue. The added and/or exchanged amino acid residue can either be codable amino acid residues or other naturally occurring residues or purely synthetic amino acid residues. Insulin analogues are also referred to as “insulin receptor ligands”. In particular, the term “derivative” refers to a polypeptide which has a molecular structure which formally can be derived from the structure of a naturally occurring peptide, for example that of human insulin, in which one or more organic substituent (e.g. a fatty acid) is bound to one or more of the amino acids. Optionally, one or more amino acids occurring in the naturally occurring peptide may have been deleted and/or replaced by other amino acids, including non-codeable amino acids, or amino acids, including non-codeable, have been added to the naturally occurring peptide.

Examples of insulin analogues are Gly(A21), Arg(B31), Arg(B32) human insulin (insulin glargine); Lys(B3), Glu(B29) human insulin (insulin glulisine); Lys(B28), Pro(B29) human insulin (insulin lispro); Asp(B28) human insulin (insulin aspart); human insulin, wherein proline in position B28 is replaced by Asp, Lys, Leu, Val or Ala and wherein in position B29 Lys may be replaced by Pro; Ala(B26) human insulin; Des(B28-B30) human insulin; Des(B27) human insulin and Des(B30) human insulin.

Examples of insulin derivatives are, for example, B29-N-myristoyl-des(B30) human insulin, Lys(B29) (N-tetradecanoyl)-des(B30) human insulin (insulin detemir, Levemir®); B29-N-palmitoyl-des(B30) human insulin; B29-N-myristoyl human insulin; B29-N-palmitoyl human insulin; B28-N-myristoyl LysB28ProB29 human insulin; B28-N-palmitoyl-LysB28ProB29 human insulin; B30-N-myristoyl-ThrB29LysB30 human insulin; B30-N-palmitoyl-ThrB29LysB30 human insulin; B29-N-(N-palmitoyl-gamma-glutamyl)-des(B30) human insulin, B29-N-omega-carboxypentadecanoyl-gamma-L-glutamyl-des(B30) human insulin (insulin degludec, Tresiba®); B29-N-(N-lithocholyl-gamma-glutamyl)-des(B30) human insulin; B29-N-(ω-carboxyheptadecanoyl)-des(B30) human insulin and B29-N-(ω-carboxyheptadecanoyl) human insulin.

Examples of GLP-1, GLP-1 analogues and GLP-1 receptor agonists are, for example, Lixisenatide (Lyxumia®), Exenatide (Exendin-4, Byetta®, Bydureon®, a 39 amino acid peptide which is produced by the salivary glands of the Gila monster), Liraglutide (Victoza®), Semaglutide, Taspoglutide, Albiglutide (Syncria®), Dulaglutide (Trulicity®), rExendin-4, CJC-1134-PC, PB-1023, TTP-054, Langlenatide/HM-11260C (Efpeglenatide), HM-15211, CM-3, GLP-1 Eligen, ORMD-0901, NN-9423, NN-9709, NN-9924, NN-9926, NN-9927, Nodexen, Viador-GLP-1, CVX-096, ZYOG-1, ZYD-1, GSK-2374697, DA-3091, MAR-701, MAR709, ZP-2929, ZP-3022, ZP-DI-70, TT-401 (Pegapamodtide), BHM-034. MOD-6030, CAM-2036, DA-15864, ARI-2651, ARI-2255, Tirzepatide (LY3298176), Bamadutide (SAR425899), Exenatide-XTEN and Glucagon-Xten.

An example of an oligonucleotide is, for example: mipomersen sodium (Kynamro®), a cholesterol-reducing antisense therapeutic for the treatment of familial hypercholesterolemia or RG012 for the treatment of Alport syndrom. Examples of DPP4 inhibitors are Linagliptin, Vildagliptin, Sitagliptin, Denagliptin, Saxagliptin, Berberine.

Examples of hormones include hypophysis hormones or hypothalamus hormones or regulatory active peptides and their antagonists, such as Gonadotropine (Follitropin, Lutropin, Choriongonadotropin, Menotropin), Somatropine (Somatropin), Desmopressin, Terlipressin, Gonadorelin, Triptorelin, Leuprorelin, Buserelin, Nafarelin, and Goserelin.

Examples of polysaccharides include a glucosaminoglycane, a hyaluronic acid, a heparin, a low molecular weight heparin or an ultra-low molecular weight heparin or a derivative thereof, or a sulphated polysaccharide, e.g. a poly-sulphated form of the above-mentioned polysaccharides, and/or a pharmaceutically acceptable salt thereof. An example of a pharmaceutically acceptable salt of a poly-sulphated low molecular weight heparin is enoxaparin sodium. An example of a hyaluronic acid derivative is Hylan G-F 20 (Synvisc®), a sodium hyaluronate.

The term “antibody”, as used herein, refers to an immunoglobulin molecule or an antigen-binding portion thereof. Examples of antigen-binding portions of immunoglobulin molecules include F(ab) and F(ab′)2 fragments, which retain the ability to bind antigen. The antibody can be polyclonal, monoclonal, recombinant, chimeric, de-immunized or humanized, fully human, non-human, (e.g., murine), or single chain antibody. In some embodiments, the antibody has effector function and can fix complement. In some embodiments, the antibody has reduced or no ability to bind an Fc receptor. For example, the antibody can be an isotype or subtype, an antibody fragment or mutant, which does not support binding to an Fc receptor, e.g., it has a mutagenized or deleted Fc receptor binding region. The term antibody also includes an antigen-binding molecule based on tetravalent bispecific tandem immunoglobulins (TBTI) and/or a dual variable region antibody-like binding protein having cross-over binding region orientation (CODV).

The terms “fragment” or “antibody fragment” refer to a polypeptide derived from an antibody polypeptide molecule (e.g., an antibody heavy and/or light chain polypeptide) that does not comprise a full-length antibody polypeptide, but that still comprises at least a portion of a full-length antibody polypeptide that is capable of binding to an antigen. Antibody fragments can comprise a cleaved portion of a full length antibody polypeptide, although the term is not limited to such cleaved fragments. Antibody fragments that are useful in conjunction with various embodiments of the present invention include, for example, Fab fragments, F(ab′)2 fragments, scFv (single-chain Fv) fragments, linear antibodies, monospecific or multispecific antibody fragments such as bispecific, trispecific, tetraspecific and multispecific antibodies (e.g., diabodies, triabodies, tetrabodies), monovalent or multivalent antibody fragments such as bivalent, trivalent, tetravalent and multivalent antibodies, minibodies, chelating recombinant antibodies, tribodies or bibodies, intrabodies, nanobodies, small modular immunopharmaceuticals (SMIP), binding-domain immunoglobulin fusion proteins, camelized antibodies, and VHH containing antibodies. Additional examples of antigen-binding antibody fragments are known in the art.

The terms “Complementarity-determining region” or “CDR” refer to short polypeptide sequences within the variable region of both heavy and light chain polypeptides that are primarily responsible for mediating specific antigen recognition. The term “framework region” refers to amino acid sequences within the variable region of both heavy and light chain polypeptides that are not CDR sequences, and are primarily responsible for maintaining correct positioning of the CDR sequences to permit antigen binding. Although the framework regions themselves typically do not directly participate in antigen binding, as is known in the art, certain residues within the framework regions of certain antibodies can directly participate in antigen binding or can affect the ability of one or more amino acids in CDRs to interact with antigen.

Examples of antibodies are anti PCSK-9 mAb (e.g., Alirocumab), anti IL-6 mAb (e.g., Sarilumab), and anti IL-4 mAb (e.g., Dupilumab).

Pharmaceutically acceptable salts of any API described herein are also contemplated for use in a drug or medicament in a drug delivery device. Pharmaceutically acceptable salts are for example acid addition salts and basic salts.

Those of skill in the art will understand that modifications (additions and/or removals) of various components of the APIs, formulations, apparatuses, methods, systems and embodiments described herein may be made without departing from the full scope and spirit of the present invention, which encompass such modifications and any and all equivalents thereof.

### BRIEF DESCRIPTION OF THE DRAWINGS

In the following, numerous examples of injection simulation devices will be described in greater detail by making reference to the drawings, in which:

FIG. 1 schematically illustrates an example of a handheld injection device,

FIG. 2 is a perspective illustration of numerous components of the injection device,

FIG. 3 is a longitudinal cross-section through the injection device,

FIG. 4 schematically illustrates a longitudinal cross-section through an example of an injection simulation device,

FIG. 5 is a longitudinal cross-section through another example of an injection simulation device,

FIG. 6 schematically illustrates a braking unit of the injection simulation device and an insert movably disposed therein,

FIG. 7 is a longitudinal cross-section through the braking unit of FIG. 6,

FIG. 8 is a transverse cross-section through the braking unit of FIGS. 6 and 7,

FIG. 9 is another transverse cross-section through the braking unit of FIGS. 6 and 7,

FIG. 10 shows another example of a braking unit for an injection simulation device and

FIG. 11 is a longitudinal cross-section through the braking unit of FIG. 9.

### DETAILED DESCRIPTION

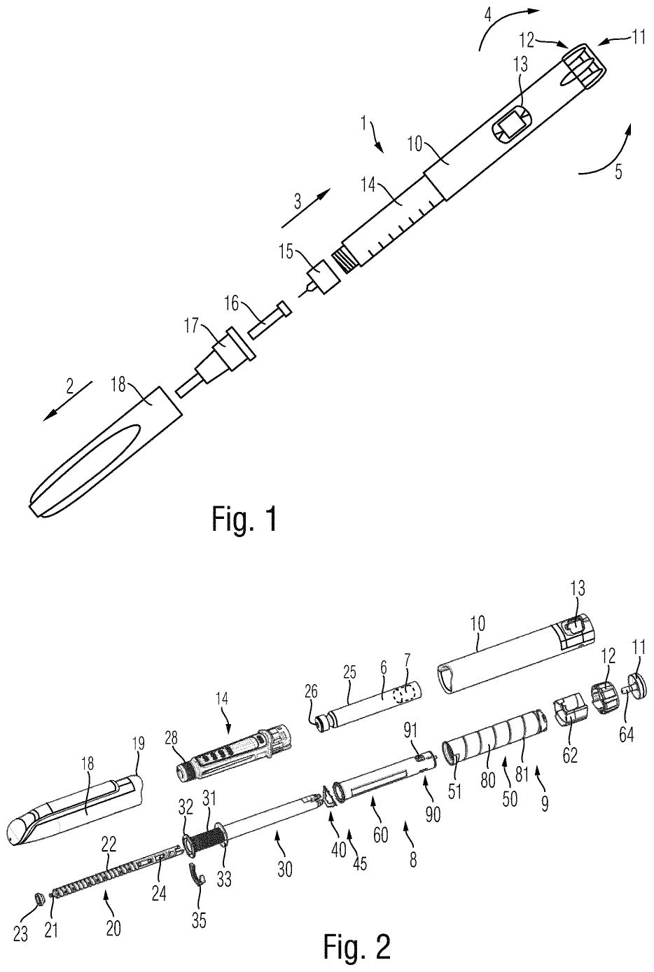

In FIGS. 1, 2 and 3 only one of numerous examples of a handheld injection device 1 is illustrated. The device as shown in FIGS. 1 and 2 is a pre-filled disposable injection device that comprises a housing 10 to which an injection needle 15 can be affixed. The injection needle 15 is protected by an inner needle cap 16 and either an outer needle cap 17 or a protective cap 18 that is configured to enclose and to protect a distal section of the housing 10 of the injection device 1. The housing 10 may comprise and form a main housing part configured to accommodate a drive mechanism 8 and/or a dose setting mechanism 9 as shown in FIG. 2. The injection device 1 may further comprise a distal housing component denoted as cartridge holder 14. The cartridge holder 14 may be permanently or detachably connected to the main housing 10. The cartridge holder 14 is typically configured to accommodate a cartridge 6 that is filled with a liquid medicament. The cartridge 6 comprises a cylindrically-shaped or tubular-shaped barrel 25 sealed in proximal direction 3 by means of a bung 7 or stopper located inside the barrel 25. The bung 7 is displaceable relative to the barrel 25 of the cartridge 6 in a distal direction 2 by means of a piston rod 20. A distal end of the cartridge 6 is sealed by a pierceable seal 26 configured as a septum and being pierceable by a proximally directed tipped end of the injection needle 15. The cartridge holder 14 comprises a threaded socket 28 at its distal end to threadedly engage with a correspondingly threaded portion of the injection needle 15. By attaching the injection needle 15 to the distal end of the cartridge holder 14 the seal 26 of the cartridge 6 is penetrated thereby establishing a fluid transferring access to the interior of the cartridge 6.

When the injection device 1 is configured to administer e.g. human insulin, the dosage set by a dose dial 12 at a proximal end of the injection device 1 may be displayed in so-called international units (IU, wherein 1 IU is the biological equivalent of about 45.5 μg of pure crystalline insulin ( 1/22 mg). The dose dial 12 may comprise or may form a dose dial.

As shown further in FIGS. 1 and 2, the housing 10 comprises a dosage window 13 that may be in the form of an aperture in the housing 10. The dosage window 13 permits a user to view a limited portion of a number sleeve 80 that is configured to move when the dose dial 12 is turned, to provide a visual indication of a currently set dose. The dose dial 12 is rotated on a helical path with respect to the housing 10 when turned during setting and/or dispensing or expelling of a dose.

The injection device 1 may be configured so that turning the dosage knob 12 causes a mechanical click sound to provide acoustical feedback to a user. The click sound is typically generated by a click noise generator 45. Generally, a click noise generator 45 may be implemented in various different ways. The number sleeve 80 mechanically interacts with a piston in the insulin cartridge 6. When the needle 15 is stuck into a skin portion of a patient, and when the trigger 11 or injection button is pushed, the dose displayed in display window 13 will be ejected from injection device 1. When the needle 15 of the injection device 1 remains for a certain time in the skin portion after the trigger 11 is pushed, the dose is actually injected into the patient's body. Ejection of a dose of the liquid medicament may also cause a mechanical click sound, which is however different from the click sound produced when using the dose dial 12. For this, the injection device one may comprise a separate, hence a second click noise generator (not illustrated).

During delivery of the insulin dose, the dose dial 12 is turned to its initial position in an axial movement, that is to say without rotation, while the number sleeve 80 is rotated to return to its initial position, e.g. to display a dose of zero units.

The injection device 1 may be used for several injection processes until either the cartridge 6 is empty or the expiration date of the medicament in the injection device 1 (e.g. 28 days after the first use) is reached.

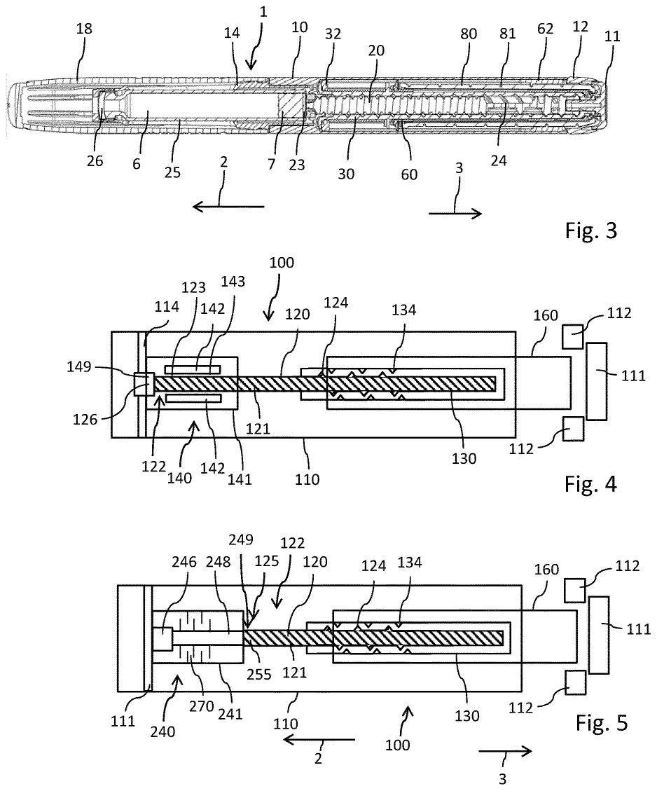

An example of the drive mechanism 8 is illustrated in more detail in FIGS. 2 and 3. It comprises numerous mechanically interacting components. A flange like support of the housing 10 comprises a threaded axial through opening threadedly engaged with a first thread or distal thread 22 of the piston rod 20. The distal end of the piston rod 20 comprises a bearing 21 on which a pressure foot 23 is free to rotate with the longitudinal axis of the piston rod 20 as an axis of rotation. The pressure foot 23 is configured to axially abut against a proximally facing thrust receiving face of the bung 7 or stopper of the cartridge 6. During a dispensing action the piston rod 20 rotates relative to the housing 10 thereby experiencing a distally directed advancing motion relative to the housing 10 and hence relative to the barrel 25 of the cartridge 6. As a consequence, the bung 7 of the cartridge 6 is displaced in distal direction 2 by a well-defined distance due to the threaded engagement of the piston rod 20 with the housing 10.

The piston rod 20 is further provided with a second thread 24 at its proximal end. The distal thread 22 and the proximal thread 24 are oppositely handed.

There is further provided a drive sleeve 30 having a hollow interior to receive the piston rod 20. The drive sleeve 30 comprises an inner thread threadedly engaged with the proximal thread 24 of the piston rod 20. Moreover, the drive sleeve 30 comprises an outer threaded section 31 at its distal end. The threaded section 31 is axially confined between a distal flange portion 32 and another flange portion 33 located at a predefined axial distance from the distal flange portion 32. Between the two flange portions 32, 33 there is provided a last dose limiter 35 in form of a semi-circular nut having an internal thread mating the threaded section 31 of the drive sleeve 30.

The last dose limiter 35 further comprises a radial recess or protrusion at its outer circumference to engage with a complementary-shaped recess or protrusion at an inside of the sidewall of the housing 10. In this way the last dose limiter 35 is splined to the housing 10. A rotation of the drive sleeve 30 in a dose incrementing direction 4 or clockwise direction during consecutive dose setting procedures leads to an accumulative axial displacement of the last dose limiter 35 relative to the drive sleeve 30. There is further provided an annular spring 40 that is in axial abutment with a proximally facing surface of the flange portion 33. Moreover, there is provided a tubular-shaped clutch 60. At a first end the clutch 60 is provided with a series of circumferentially directed saw teeth. Towards a second opposite end of the clutch 60 there is located a radially inwardly directed flange.

Furthermore, there is provided a dose dial sleeve also denoted as number sleeve 80. The number sleeve 80 is provided outside of the spring 40 and the clutch 60 and is located radially inward of the housing 10. A helical groove 81 is provided about an outer surface of the number sleeve 80. The housing 10 is provided with the dosage window 13 through which a part of the outer surface of the number 80 can be seen. The housing 10 is further provided with a helical rib at an inside sidewall portion of an insert piece 62, which helical rib is to be seated in the helical groove 81 of the number sleeve 80. The tubular shaped insert piece 62 is inserted into the proximal end of the housing 10. It is rotationally and axially fixed to the housing 10. There are provided first and second stops on the housing 10 to limit a dose setting procedure during which the number sleeve 80 is rotated in a helical motion relative to the housing 10.

The dose dial 12 in form of a dose dial grip is disposed about an outer surface of the proximal end of the number sleeve 80. An outer diameter of the dose dial 12 typically corresponds to and matches with the outer diameter of the housing 10. The dose dial 12 is secured to the number 80 to prevent relative movement there between. The dose dial 12 is provided with a central opening.

The trigger 11, also denoted as dose button is substantially T-shaped. It is provided at a proximal end of the injection device 10. A stem 64 of the trigger 11 extends through the opening in the dose dial 12, through an inner diameter of extensions of the drive sleeve 30 and into a receiving recess at the proximal end of the piston rod 20. The stem 64 is retained for limited axial movement in the drive sleeve 30 and against rotation with respect thereto. A head of the trigger 11 is generally circular. The trigger side wall or skirt extends from a periphery of the head and is further adapted to be seated in a proximally accessible annular recess of the dose dial 12.

To dial a dose a user rotates the dose dial 12. With the spring 40, also acting as a click noise generator 45, and the clutch 60 engaged, the drive sleeve 30, the spring 40, the clutch 60 and the number sleeve 80 rotate with the dose dial 12. Audible and tactile feedback of the dose being dialed is provided by the spring 40 and by the clutch 60. Torque is transmitted through saw teeth between the spring 40 and the clutch 60. The helical groove 81 on the number sleeve 80 and a helical groove in the drive sleeve 30 have the same lead. This allows the number sleeve 80 to extend from the housing 10 and the drive sleeve 30 to climb the piston rod 20 at the same rate. At a limit of travel a radial stop on the number sleeve 80 engages either with a first stop or a second stop provided on the housing 10 to prevent further movement in a first sense of rotation, e.g. in a dose incrementing direction 4. Rotation of the piston rod 20 is prevented due to the opposing directions of the overall and driven threads on the piston rod 20.

The last dose limiter 35 keyed to the housing 10 is advanced along the threaded section 31 by the rotation of the drive sleeve 30. When a final dose dispensed position is reached, a radial stop formed on a surface of the last dose limiter 35 abuts a radial stop on the flange portion 33 of the drive sleeve 30, preventing both, the last dose limiter 35 and the drive sleeve 30 from rotating further.

Should a user inadvertently dial beyond the desired dosage, the injection device 1, configured as a pen-injector allows the dosage to be dialed down without dispense of the medicament from the cartridge 6. For this the dose dial 12 is simply counter-rotated. This causes the system to act in reverse. A flexible arm of the spring or clicker 40 then acts as a ratchet preventing the spring 40 from rotating. The torque transmitted through the clutch 60 causes the saw teeth to ride over one another to create the clicks corresponding to dialed dose reduction. Typically, the saw teeth are so disposed that a circumferential extent of each saw tooth corresponds to a unit dose. Here, the clutch may serve as a ratchet mechanism.

As an alternative or in addition the ratchet mechanism 90 may comprise at least one ratchet feature 91, such as a flexible arm on the sidewall of the tubular-shaped clutch 60. The at least one ratchet feature 91 may comprise a radially outwardly extending protrusion e.g. on a free end of the flexible arm. The protrusion is configured to engage with a correspondingly shaped counter ratchet structure on an inside of the number sleeve 80. The inside of the number sleeve 80 may comprise longitudinally shaped grooves or protrusions featuring a saw-tooth profile. During dialing or setting of a dose the ratchet mechanism 90 allows and supports a rotation of the number sleeve 80 relative to the clutch 60 along a second sense of rotation 5, which rotation is accompanied by a regular clicking of the flexible arm of the clutch 60. An angular momentum applied to the number sleeve 80 along the first sense of rotation for is unalterably transferred to the clutch 60. Here, the mutually corresponding ratchet features of the ratchet mechanism 90 provide a torque transmission from the number sleeve 80 to the clutch 60.

When the desired dose has been dialed the user may simply dispense the set dose by depressing the trigger 11. This displaces the clutch 60 axially with respect to the number sleeve 80 causing dog teeth thereof to disengage. However, the clutch 60 remains keyed in rotation to the drive sleeve 30. The number sleeve 80 and the dose dial 12 are now free to rotate in accordance with the helical groove 81.

The axial movement deforms the flexible arm of the spring 40 to ensure the saw teeth cannot be overhauled during dispense. This prevents the drive sleeve 30 from rotating with respect to the housing 10 though it is still free to move axially with respect thereto. The deformation is subsequently used to urge the spring 40 and the clutch 60 back along the drive sleeve 30 to restore the connection between the clutch 60 and the number sleeve 80 when the distally directed dispensing pressure is removed from the trigger 11.

The longitudinal axial movement of the drive sleeve 30 causes the piston rod 20 to rotate through the through opening of the support of the housing 10, thereby to advance the bung 7 in the cartridge 6. Once the dialed dose has been dispensed, the number sleeve 80 is prevented from further rotation by contact of at least one stop extending from the dose dial 12 with at least one corresponding stop of the housing 10. A zero dose position may be determined by the abutment of one of axially extending edges or stops of the number sleeve 80 with at least one or several corresponding stops of the housing 10.

The expelling mechanism or drive mechanism 8 as described above is only exemplary for one of a plurality of differently configured drive mechanisms that are generally implementable in a disposable pen-injector. The drive mechanism as described above is explained in more detail e.g. in WO2004/078239A1, WO 2004/078240A1 or WO 2004/078241A1 the entirety of which being incorporated herein by reference. The injection device 1 comprises a dial extension, e.g. formed by the drive sleeve 30, the clutch 60, the number 80, the dose dial and the trigger 11, and which dial extension is subject to a reversable longitudinal movement relative to the housing 10 during and/or for setting and injecting of the dose. The magnitude of longitudinal displacement of the dial extension may coincide or match with a variable size of a dose to be set or injected.

In FIGS. 4-11 there are illustrated numerous examples of an injection simulation device 100. In principle, the injection simulation device 100 may be directly derived from an injection device 1 as described above in connection with FIGS. 1-3. The injection simulation device 100 may comprise an injection simulation mechanism, which is somehow identically shaped or identically implemented compared to the drive mechanism 8 or the dose setting mechanism 9 of the injection device 1 as described above. In effect and in some examples the injection simulation device 100 may only or effectively distinguish from the injection device 1 by substituting the piston rod 22 by a rotatable element 120 implemented as a longitudinal rod 121.

The longitudinal rod 121 may comprise a threaded portion 124, which is in threaded engagement with a correspondingly shaped threaded section 134 on the inside of a driver 130. The driver 130 may be implemented identical or at least functionally similarly compared to the drive sleeve 30 as described in connection with FIGS. 1-3. The driver 130 is typically subject to a helical motion relative to the housing 110 and hence relative to the rotatable element 120 during setting of a dose. Setting of a dose may be induced or controlled by a dose dial 112, which may be mechanically coupled to the driver 130 in a similar or rather identical manner as the dose dial 12 is mechanically engaged with the drive sleeve 30 of the injection device 1.

Insofar and during or for setting of a dose a user may use the dose dial 112 and rotate the dose dial 112 e.g. in a dose incrementing direction 4 until a dose of desired size shows up in an aperture or window 13. The user may then actuate the trigger 111, e.g. provided at a distal end of the dose dial 112, thereby exerting a distally directed dispensing force onto a dial extension and hence onto the driver 130 in distal direction 2. By depressing of the trigger 111, a mechanical coupling 160 between the trigger 111 and the rotatable element 120 may be switched between a locked state and an unlocked state.

By depressing the trigger 111 the mechanical coupling 160, e.g. implemented like the clutch 60 of the injection device 1, may be operable to rotationally lock the driver 130 relative to the housing 110, such that the driver 130 is subject to a non-rotating longitudinally distally directed displacement relative to the housing 110. As the user applies a distally directed force onto the trigger 111, the driver 130 is then subject to a non-rotating distally directed sliding motion relative to the housing 110, which due to the threaded engagement between the threaded section 134 of the driver 130 with the threaded portion 124 of the rotatable element 120 leads to a respective rotation of the rotatable element along a first sense of rotation. Concurrent with the distally directed sliding movement of the driver 130 an optional number sleeve 80 of the injection training device 100 may rotate back into its initial position or configuration.

The rotatable element 120 comprises a longitudinally extending rod 121 with a distal end 122. The distal end 122 is rotationally supported by a pivot bearing 126, which in the example of FIG. 4 is fastened to the housing 110 through a transverse extending web portion 114 or flange. By way of the pivot bearing 126 the rotatable element 120 is longitudinally fixed to the housing 110 and is free to rotate relative to the housing 110 with respect to its longitudinal axis of symmetry.

The injection training or simulation device 100 further comprises a brake unit 140. The brake unit 140 may comprise a unit housing 141 enclosing a brake element 142 as shown in FIG. 4. The brake element 142 may comprise a brake shoe. The brake element comprises a friction surface 143 facing radially inwardly towards an outside counter friction surface 123 of the longitudinal rod 121. The friction surface 143 is frictionally engaged with the counter friction surface 123, thereby providing a well-defined friction between the brake element 142 and the rotatable element 120.

There may be provided numerous brake elements 142 around the circular circumference of the rotatable element 120. The brake unit 140 may be arranged at or near the distal end 122 of the rotatable element 120. Here and by way of the pivot bearing 126 there can be provided a rather precise guiding and support for the rotatable element 120, which is beneficial to provide a well-defined frictional engagement between the non-rotating brake element 142 and the rotating rotatable element 120.

In the example of FIG. 4, the rotatable element 120, hence the longitudinal rod 121 may extend longitudinally through the brake unit 140 and hence through the unit housing 141 in longitudinal direction. The distal end 122 of the rotatable element 120 may be received or may be mechanically engaged with a mount 149 of the pivot bearing 126, thereby providing a rather precise and well-defined rotational support for the distal end 122 of the rotatable element 120.

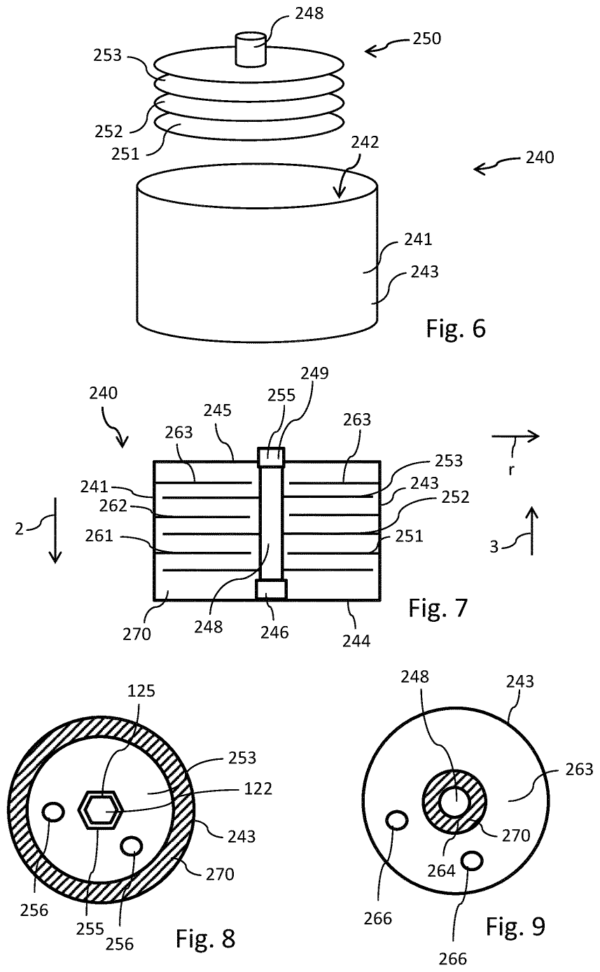

In the further example of FIG. 5 there is provided another brake unit 240. The brake unit 240, which is shown in greater detail also in FIGS. 6-9, comprises a unit housing 241, which may be an encapsulated housing providing a cylindrically-shaped sealed cavity 242 filled with a damping fluid 270. The brake unit 240 comprises a cylindrically-shaped unit housing 241. The unit housing 241 comprises a cylindrically-shaped sidewall 243 confined in longitudinal direction by a top 245 and an oppositely located planar bottom 244. Inside the cavity 242 there extends a longitudinally extending shaft 248, which is rotationally supported inside the cavity 242. Here, a distal end of the shaft 248 is rotationally supported by a pivot bearing 246, which may be fastened to the bottom 244 or which may be located on or integrated into the bottom 244.

An opposite proximal end of the shaft 248 may be provided with a mount 249. The mount 249 may be provided with a mechanical coupling 255, complementary shaped to a mechanical counter coupling 125 as provided at the distal end 122 of the rotatable element 120. The coupling 255 and the counter coupling 125 may be in torque-proof engagement. They may comprise a keyed structure or cross section and hence a symmetry breaking feature by way of which and when overlapping in longitudinal direction there can be established a rotational coupling between the shaft 248 and the rotatable element 120.

Here and with the example of FIGS. 5-9 the distal end 122 of the rotatable element 120 is provided with the counter coupling 125 and is in torque proof engagement with the mount 249 and hence with the coupling 255 of the brake unit 240. As it is apparent from FIG. 5 the longitudinal shaft 248 of the brake unit 240 is implemented as a longitudinal extension of the rotatable element 120. Also, the shaft 248 is rotationally coupled and is rotationally locked to the rotatable element 120.

The brake unit 240 comprises an insert 250 as shown in FIG. 6. The insert 250 comprises the longitudinally extending shaft 248 and numerous lamellas 251, 252, 253. Each lamella 251, 252, 253 comprises a circular disc and is rotationally fixed to the shaft 248. Insofar a rotation of the shaft 248 as induced by a rotation of the rotatable element 120, e.g. in the course of simulating an injection of a dose also leads to a respective rotation of the lamellas 251, 252, 253.

As it is further apparent from the cross-sections of FIGS. 7-9 the brake unit 240 comprises numerous counter lamellas 261, 262, 263. As seen in longitudinal direction 2, 3 the lamellas 251, 252, 253 and the counter lamellas 261, 262, 263 are arranged in an alternating and hence staggered or interleaved manner. As seen in longitudinal proximal direction and starting from the bottom 244 of the brake unit a first lamella 251 is followed by a first counter lamella 261. The first counter lamella 261 is followed by a second lamella 252. The second lamella 252 is followed by a second counter lamella 262. The second counter lamella 262 is followed in proximal direction by a third lamella 253 and the third lamella 253 is followed by a third counter lamella 263.

The longitudinal gap size between the lamellas and the counter lamellas might be crucial for a magnitude or characteristic of retarding effect and hence of a braking force of braking momentum provided by the brake unit 240. Since the cavity 242, which encloses the counter lamellas 261, 262, 263 and the lamellas 251, 252, 253, is filled with a dampening fluid, a rotation of the insert 250 relative to the unit housing 241 is effectively dampened by the dampening fluid 270.

The lamellas 251, 252, 253 are fixed to the rotatable shaft 248. The counter lamellas 261, 262, 263 are fixed to an inside of the sidewall 243 of the unit housing 241. The unit housing 241 is fixed and fastened to the housing 110 of the injection simulation device 100.

As it is particularly apparent from FIG. 9 the counter lamella 263 is connected with a radial outside to an inside of the sidewall 243 of the unit housing 241. The counter lamella 263 comprises a central through opening 264 or a respective aperture, which is slightly larger than the circumference or cross-section of the shaft 248. The counter lamellas 261, 262, 263 are aligned in longitudinal direction, such that the respective through openings 264 are longitudinally aligned. This way, the shaft 248 may extend longitudinally through the respective through openings 264.

Optionally, the disc-shaped lamellas 251, 252, 253 as well as the counter lamellas 261, 262, 263 comprise one or numerous through openings 256, 266, respectively. By way of the through openings 256, 266, the dampening effect of the dampening fluid 270 can be influenced and modified.

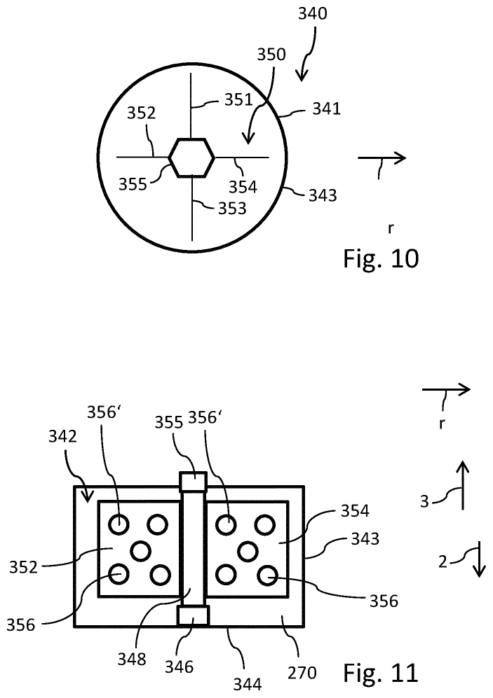

In the further example of FIGS. 10 and 11 there is implemented another brake unit 340. With the brake unit 340, at least the unit housing 341 one is substantially identical to the unit housing 241 of the brake unit 240. Also, the brake unit 340 comprises a cavity 342, confined by a cylindrically-shaped sidewall 343, a planar and circular shaped bottom 344 and a respective top 345 opposite the bottom 344 and separated as well as connected to the bottom 344 via the sidewall 343.

Also here, there is provided a longitudinally extending shaft 348 rotationally supported by a pivot bearing 346 at the bottom 344 of the unit housing 341. An opposite end of the shaft 348, hence a proximal end of the shaft 348 is provided with a mount 349 and a respective coupling 355 to provide a torque-proof and hence torque-transferring mechanical coupling with the distal end 122 of the rotatable element 120. The brake unit 340 and hence the unit housing 341 is mechanically fixed to the housing 110 of the injection simulation device 100.

Instead of a number of disc-shaped lamellas and counter lamella as described in connection with the example of FIGS. 5-9 the brake unit 340 comprises numerous blades 351, 352, 353, 354 that are fixed to the rotatable shaft 348. As it is apparent from the combination of FIGS. 10 and 11 the blades 351, 352, 353, 354 extend equiangularly and radially outwardly from the shaft 348. The blades 351, 352, 353, 354 also comprise a respective extension in longitudinal direction, hence in distal direction 2 or proximal direction 3 as indicated in FIG. 11. They may have a longitudinal extension that is slightly less than the longitudinal extent of the cavity 342. Likewise, the blades 351, 352, 353, 354 may comprise a radial extent that is slightly less than half of the diameter of the cavity 342. Of course, the pivot bearing 346 and hence the longitudinal shaft 348 are arranged in a radial center of the cavity 342 and hence of the unit housing 341.

A first blade 351 may be arranged geometrically opposite to a third blade 353. A second blade 352 may be arranged diametrically opposite to a fourth blade 354. Hence, the third blade 353 may be a longitudinal or hence radial extension of the first blade 351. The fourth blade 354 may be a radial extension of the second blade 352. With the angular arrangement of numerous blades 351, 352, 353, 354, there can be provided a rather homogeneous force distribution across the cross-section of the tubular shaped cavity 342. With the example of four blades 351, 352, 353, 354, the angular distance between neighboring blades may be about 90°. With only three blades the angular distance between circumferential neighboring blades may be about 120°. With only two blades the angular distance between them may be about 180°. Also, with an increasing number of blades, e.g. with six blades, the angular distance between the circumferentially adjacently located blades may be about 60°.

Since the blades 351, 352, 353, 354 are rather stiff and/or rigid and since the blades are also in torque-proof engagement with the rotatable shaft 348, they provide a respective resistance as the blades 351, 352, 353, 354 are subject to a movement or rotation due to a rotating shaft 348 while the blades 351, 352, 353, 354 are at least partially or completely immersed in the dampening fluid 270.

Also here, a retarding force, hence a braking force or a braking momentum provided by the brake unit 340 can be modified and hence designed by either selecting a suitable dampening fluid 270 comprising a desired viscosity. Also, the geometry and hence the size and/or the number as well as the relative orientation of numerous blades 351, 352, 353, 354 can be modified accordingly.

In addition, the blades 351, 352, 353, 354 may be provided with one or numerous through openings 356, 356′. Also, and by way of modifying at least one of a size, a number and a geometry of the individual through openings 356, 356′ a retarding force or retarding effect emanating from of the blades 351, 352, 353, 354 can be modified in order to match with predefined demands of the brake unit 340 and/or in order to provide a brake unit 340 that exhibits a required characteristic, e.g. a linear or non-linear braking behavior, e.g. with respect to variations of an angular velocity of the rotating element.

### REFERENCE NUMBERS

1 injection device
2 distal direction
3 proximal direction
4 dose incrementing direction
5 dose decrementing direction
6 cartridge
7 bung
8 drive mechanism
9 dose setting mechanism
10 housing
11 trigger
12 dose dial
13 dosage window
14 cartridge holder
15 injection needle
16 inner needle cap
17 outer needle cap
18 protective cap
20 piston rod
21 bearing
22 first thread
23 pressure foot
24 second thread
25 barrel
26 seal
28 threaded socket
30 drive sleeve
31 threaded section
32 flange
33 flange
35 last dose limiter
40 spring
45 click noise generator
60 clutch
62 insert piece
64 stem
80 number sleeve
81 groove
90 ratchet mechanism
91 ratchet feature
100 injection simulation device
110 housing
111 trigger
112 dose dial
114 web
120 rotatable element
121 longitudinal rod
122 distal end
123 counter friction surface
124 threaded portion
125 counter coupling
126 pivot bearing
130 driver
134 threaded section
140 brake unit
141 unit housing
142 brake element
143 friction surface
149 mount
240 brake unit
241 unit housing
242 cavity
243 sidewall
244 bottom
245 top
246 pivot bearing
248 shaft
249 mount
250 insert
251 lamella
252 lamella
253 lamella
255 coupling
256 through opening
261 counter lamella
262 counter lamella
263 counter lamella
264 through opening
266 through opening
270 damping fluid
340 brake unit
341 unit housing
342 cavity
343 sidewall
344 bottom
345 top
346 pivot bearing
348 shaft
349 mount
350 insert
351 blade
352 blade
353 blade
354 blade
355 coupling
356 through opening

1-18. (canceled)

19. An injection simulation device operable to simulate an injection of a dose of a medicament, the injection simulation device comprising
a housing defining a longitudinal direction,
a rotatable element arranged inside the housing, rotatable relative to the housing and constrained to the housing with regard to the longitudinal direction
a trigger manually operable by a user to initiate or to control the simulated injection of the dose,
a mechanical coupling mechanically engaged with the trigger and with the rotatable element, the mechanical coupling being operable to induce or to transfer operation of the trigger into rotation of the rotatable element relative to the housing along a first sense of rotation,
a brake unit fixed to the housing and in torque-proof engagement with the rotatable element, the brake unit being operable to apply a braking force or braking momentum onto the rotatable element.

20. The injection simulation device according to claim 19, wherein the brake unit is operable to apply a braking force or braking momentum of variable magnitude onto to rotatable element, wherein the magnitude of the braking force or braking momentum varies with an angular velocity of the rotatable element relative to the housing.

21. The injection simulation device according to claim 20, wherein the magnitude of the braking force or braking momentum applicable by the brake unit onto the rotatable element increases with an increasing angular velocity.

22. The injection simulation device according to claim 19, wherein the rotatable element comprises a longitudinal rod.

23. The injection simulation device according to claim 19, wherein the rotatable element comprises a distal end, which is rotatably supported by a pivot bearing.

24. The injection simulation device according to claim 19, wherein the brake unit comprises a mount for the distal end of the rotatable element.

25. The injection simulation device according to claim 24, wherein the mount comprises a mechanical coupling structure complementary shaped to a counter coupling structure of the rotatable element.

26. The injection simulation device according to claim 19, wherein the brake unit comprises a brake element with a radially facing friction surface to frictionally engage with a complementary shaped circumferential counter friction surface of the rotatable element.

27. The injection simulation device according to claim 19, wherein the brake unit comprises a cylindrical cavity containing a dampening fluid.

28. The injection simulation device according to claim 27, wherein the brake unit comprises a shaft rotatable inside a unit housing, wherein the unit housing confines the cylindrical cavity, wherein one of the shaft and the unit housing is rotationally locked to the rotatable element and wherein the other one of the shaft and the unit housing is rotationally locked to the housing.

29. The injection simulation device according to claim 28, wherein the brake unit comprises at least one of a lamella and a blade fixed to one of the shaft and the unit housing, being immersed in the dampening fluid and extending radially from one of the shaft and the unit housing.

30. The injection simulation device according to claim 29, wherein the brake unit comprises at least a fist lamella and a second lamella, wherein the first lamella and the second lamella are fixed to one of the shaft and the unit housing at a longitudinal distance from each other and wherein the brake unit further comprises at least a first counter lamella fixed to the other one of the shaft and the unit housing longitudinally between the first lamella and the second lamella.

31. The injection simulation device according to claim 29, wherein the brake unit comprises a first blade and at least a second blade fixed to one of the shaft and the unit housing and protruding equiangularly form the shaft or from the unit housing in a radial and longitudinal direction.

32. The injection simulation device according to claim 29, wherein at least one of the lamella and the blade comprises at least one of a through opening and a grid structure.

33. The injection simulation device according to claim 19, wherein the rotatable element is longitudinally locked to the housing.

34. The injection simulation device according to claim 19, wherein the trigger is movable from a first position to a second position by manually applying a dispensing force onto the trigger and wherein a distance between the first position and the second position correlates with a degree of rotational displacement of the rotatable element.

35. The injection simulation device according to claim 34, wherein a magnitude of the dispensing force required to move the trigger from the first position to the second position depends on a magnitude of the braking force or breaking momentum applied by the brake unit onto the rotatable element.

36. A method of simulating an injection of a dose of a medicament comprising the steps of:
providing an injection simulation device, comprising
a housing defining a longitudinal direction,
a rotatable element arranged inside the housing, rotatable relative to the housing and constrained to the housing with regard to the longitudinal direction
a trigger manually operable by a user to initiate or to control the simulated injection of the dose,
a mechanical coupling mechanically engaged with the trigger and with the rotatable element, the mechanical coupling being operable to induce or to transfer operation of the trigger into rotation of the rotatable element relative to the housing along a first sense of rotation,
a brake unit fixed to the housing and in torque-proof engagement with the rotatable element, the brake unit being operable to apply a braking force or braking momentum onto the rotatable element; and
conducting an injection simulation by actuating the trigger of the injection simulation device.
